(19) United States
(12) Patent Application Publication
(10) Pub. No.: US 2024/0417329 A1
(43) Pub. Date: Dec. 19, 2024

(54) METHOD AND DEVICE FOR THE PRODUCTION OF MOULDED COMPONENTS

(71) Applicant: PARASTRUCT GMBH, Innsbruck (AT)

(72) Inventor: Georg BREITENBERGER, Innsbruck (AT)

(21) Appl. No.: 18/703,955

(22) PCT Filed: Oct. 25, 2022
(86) PCT No.: PCT/AT2022/060370

§ 371 Date: Apr. 23, 2024

(30) Foreign Application Priority Data
Oct. 27, 2021 (AT) A 50851/2021

(51) Int. Cl. C04B 28/10; B22C 1/18; B22C 3/00; B33Y 10/00; B33Y 30/00; C04B 111/00

(52) U.S. Cl. CPC C04B 28/105; B22C 1/181; B22C 3/00; B33Y 10/00; B33Y 30/00; C04B 2111/00181; C04B 2111/00939; C04B 2201/20

(57) ABSTRACT

A method of producing an additively manufactured casting mould for the production of components using the cold casting process or lamination process, comprising the steps of
a) determining a three-dimensional structure of the casting mould,
b) providing a mixture, the mixture comprising a binding agent and an aggregate,
c) providing a printing fluid comprising an aqueous solution of magnesium chloride or magnesium sulfate,
d) applying a layer of the mixture to a support,
e) applying the printing fluid only to those parts of the mixture which are supposed to constitute a part of the casting mould,
f) applying a further layer of the mixture to the previous layer of the mixture,
g) applying the printing fluid only to those parts of the mixture which are supposed to constitute a part of the casting mould,
h) repeating steps f) and g) until the desired shape of the casting mould is achieved,
i) allowing those parts of the mixture to set which have been mixed with the aqueous solution of magnesium chloride or magnesium sulfate,
j) removing the mixture which has not been mixed with an aqueous solution, and coating with a formwork skin at least those parts of the casting mould which come into contact with the material of the cold-casting lamination process.

The present invention relates to a method of producing an additively manufactured casting mould for the production of complex components using the cold casting process or lamination process.

### BACKGROUND OF THE INVENTION

Computer-assisted methods allow architects and engineers to design complex components made of, for example, concrete with high geometric complexity. The practical conversion of such designs into reality often fails due to high manufacturing costs or the fact that manufacture using conventional manufacturing methods and tools is impossible.

Additive manufacturing allows the production of complex components from construction materials such as, for example, concrete by manufacturing the shaping component-subsequently the casting mould or occasionally the formwork-additively instead of by machining using a CNC-controlled milling machine or by hand from wood or synthetic materials.

The use of additive manufacturing in mould making is well known. For example, casting moulds made of sand are manufactured for foundries in the binder jetting process using 3D printers in order to produce complex machine components. WO 2011/021080 A2 describes, for example, a binder jetting process in the construction industry.

There are various additive methods which can be used for this. Methods based on powder beds (binder jetting) and methods based on extrusion have proved to be most advantageous for producing such moulds. EP 3 174 651 B1 from Voxeljet AG describes the production of such a casting mould using a method based on powder beds, also known by the term binder jetting. In this process, a powdered starting material is bonded at selected points to a binding agent—the “binder”. In this method, the workpieces are built layer by layer by calculating the geometry to be generated for each individual layer from 3D data (e.g., CAD data). Subsequently, a layer of powder or granules is applied to a height-adjustable table and bonded to the binder using a print head at the points that belong to the workpiece. Afterwards, the table is lowered by a layer thickness and a new powder layer is applied. This is repeated until the workpiece is fully developed, which is then completely concealed by the surrounding powder. Excess powder is then returned for further use, the workpiece is removed from the printer and freed from powder residue. It is also possible in this way to produce casting moulds for the construction industry.

In EP 3 174 651 B1, it is described that such casting moulds are made of sand that is pre-coated with an activator component and are selectively bound to a synthetic resin, usually phenolic resin, in that the activator component and the synthetic resin form a polymer. The casting mould resulting therefrom has pores, and it is therefore smoothed by a black wash and then by a plastic-based sealant such as PU, epoxy resin, polyester, etc. in order to be used as a formwork in construction. This multi-step process, which consists of printing the formwork, removing loose particulate material from the formwork, applying the black wash for closing the pores so that the sealant is not pressed into the pores by the concrete pressure, and applying the sealant itself, is very complex. In addition, certain downtimes and rest periods must be observed between the process steps. As expensive synthetic resins are used as binding agents and a plastic coating is used as a sealant, the heavy formworks made of sand become hazardous waste after use and must be disposed of in a complex and costly manner. Since sand is the main component of the casting mould, the latter has a very high weight and is therefore difficult to handle. Special lifting devices are therefore required for knocking, lifting, moving and setting down.

Other prior art documents include, for example, DE 10 2017 009 742 A1, wherein a water-soluble mould manufactured by a powder-based layering process is described. In this case, the process is similar to the method described in EP 3 174 651 B1, but a water-soluble synthetic material is used as the binding agent. On the other hand, quartz sand, for example, is used as a water-insoluble component. This process is preferably used for complex geometries with undercuts. The use of this binding agent enables the manufacture of components with a strength of 0.8-1.5 N/mm². Subsequent oven treatment can enhance the strength to >2 N/mm². Because of the use of cost-intensive plastic-based binders and sand as a particulate material with a high dead weight and due to the low strength of the moulds, this process also fails to be economical. In addition, long downtimes and oven treatments are required. The sand can indeed be reused after the binder has dissolved, but it must first be completely freed from the binder and dirt and must then be dried. The binding agent dissolved in the water must be disposed of separately.

In DE 10 2016 119 365 A1, a modular formwork system printed from synthetic materials is described, wherein at least the surface facing the concrete consists of a synthetic material that has been applied in layers and cured. The modular individual moulds consist of a reusable base support and a detachable, recyclable synthetic material, which can also be soluble in water. The formworks are manufactured from a plastic filament in an extrusion process, which is lengthy in terms of the production of moulded bodies with a large volume, due to the limited number of print heads. Moreover, an operation in the extrusion process leaves behind a grooved surface which can be smoothed only with considerable effort, or printing is done with such a small layer thickness that the production will happen even more slowly. The use of synthetic materials for the production of bulky components involves high costs, as recycling requires the removal of contaminants such as formwork oils, concrete residues, cement slurries, dust particles, etc. Due to the reusable base supports, mould making involves being bound to the specifications from the base supports, which can be regarded as a limitation in the production and contradicts the fundamental principle of additive manufacturing, total freedom of design in every component.

EP 2 961 581 B1 describes the production of an additively manufactured, porous, water-soluble casting mould from various materials. After use, the mould is dissolved in a temperature-controlled water bath or autoclave and the waterproof formwork skin is washed off from the cast component. Disadvantages of this method include the inefficiency thereof. Each formwork can only be used once. Furthermore, large amounts of water are required for dissolving the formwork. The water must be treated after use, and the substances dissolved therein must be filtered out.

US 2015/315399 A1 describes a powder mixture made of a soluble adhesive consisting of a cement containing magnesium oxide and an acid additive. In addition, the mixture contains a non-reactive ceramic filler. The acid additive is added to the powder, the powder is thus reactive at all times, and clump formation as well as a reaction may occur as a result of atmospheric humidity. The printing fluid consists of a solvent and an acidic additive by up to 50%.

US 2011/7177188 A1 describes a powder mixture for the 3D printing binder jetting process in order to thereby produce 3D printed moulds for iron casting. The powder mixture consists of a binding agent, sand and an accelerator. Cement, preferably Portland cement or pozzolanic cement or fly ash, is used as the binding agent. The cement itself may contain lime and alkaline oxides. The reactive alkaline oxides are: calcium oxide, magnesium oxide or zinc oxide. A soluble silicate, such as water glasses, is present as the accelerator. The mixture of Portland cement and magnesium oxide is viewed critically. If the cement contains too much magnesium oxide, magnesian expansion will occur and the hardening structure will be destroyed. The use of sodium water glass is prohibited in construction, for example.

DE 3 506 555 A1 describes the production of mortar-like masses based on magnesium oxide as a binding agent and magnesium sulfate as a stimulator. Biological materials such as wood chips are used as aggregates. Up until the 1950s, magnesium oxide was used for the manufacture of floors. Chips, sawdust, etc. were thus added to the mixture so that the floor would feel warm to the feet. Better water resistance was hoped to be achieved by stimulation with magnesium sulfate.

DE 2 922 815 A1 deals with the idea of improving the water resistance of magnesium oxide by adding ethyl silicate.

CN 110342898 A describes the use of magnesium oxide and magnesium sulfate as binding agents for 3D printing. Talcum powder and dolomite powder are used as aggregates. Talc and dolomite are described in the literature as aggregates that can be easily combined with MgO.

### BRIEF DESCRIPTION OF THE INVENTION

The disadvantages known from the prior art render the use of additively manufactured castings moulds impractical, for example, in the construction industry or in boat building, since such castings moulds are either uneconomical due to the complex production or cause problems because of the large masses. In addition, the castings moulds of the prior art can usually only be used once, and they have to be disposed of afterwards at great expense.

It is therefore the object of the present invention to provide a method of producing a casting mould as well as a casting mould itself, wherein these disadvantages are reduced.

This object is achieved by a method of producing an additively manufactured casting mould for the production of components using the cold casting process or lamination process, comprising the steps of
a) determining a three-dimensional structure of the casting mould,
b) providing a mixture, the mixture comprising a powdered binding agent and a powdered aggregate,
c) providing a printing fluid comprising an aqueous solution of magnesium chloride or magnesium sulfate,
d) applying a layer of the mixture to a support,
e) applying the printing fluid only to those parts of the mixture which are supposed to constitute a part of the casting mould,
f) applying a further layer of the mixture to the previous layer of the mixture,
g) applying the printing fluid only to those parts of the mixture which are supposed to constitute a part of the casting mould,
h) repeating steps f) and g) until the desired shape of the casting mould is achieved,
i) allowing those parts of the mixture to set which have been mixed with the aqueous solution of magnesium chloride or magnesium sulfate,
j) removing the mixture which has not been mixed with an aqueous solution, and
k) coating with a formwork skin at least those parts of the casting mould which come into contact with concrete.

Before the invention is described in detail, some terms of the invention are explained in more detail below.

3D printing processes are all applicable processes known from the prior art that enable the construction of free-form components. There exist, for example, binder jetting, contour crafting, stereolithography.

Selective binding can occur after each application of particulate material. It takes place where it is intended by the 3D CAD model.

Particulate material is any material that is suitable for powder-based 3D printing.

For the purposes of the invention, a particulate material mixture is a material mixture of at least two different materials. For the purposes of the invention, it consists of an aggregate and a binding agent.

Aggregate: All bulk materials from the construction industry, preferably lightweight construction materials such as expanded perlite, expanded slate, expanded clay, etc.

Binding agent: All binding agents suitable for the construction industry such as gypsum, cement, lime, magnesium oxide, magnesium sulfate, anhydrite, silicates, etc.

Re-calcination: after its use and processing, the reacted binding agent is burnt once more and thus becomes reactive again.

Printing fluid: It is selectively applied to the particulate material by the print head and triggers a reaction in the particulate material in which the components in the particulate material combine and, in their totality, ultimately form the moulded body.

In the present case, a solution of magnesium chloride MgCl₂ is preferably used as the printing fluid. The chloride assumes the function of the catalyst in the setting process. Preferably, a concentrated solution is used whose specific gravity at 20° C. is 1.25 kg/l. The MgCl₂ content should be at least 25% by weight. In order to achieve good strength, the optimal weight ratio between MgO and MgCl₂ solution is between 1 and 2, particularly preferably 1.5. The optimal ratio between the reactants is determined by the stoichiometry MgCl₂/Mg=1.5, whereas, in the 3D printing process, the ratio is often reduced a little and is between 1 and 1.5. Magnesium sulfate can also be used, with the mass ratios being appropriate. However, MgCl₂ has better properties. On the one hand, this is due to the hygroscopic properties of MgSO₄, i.e., the ability to attract water from the environment. On the other hand, the combination of MgCl₂ in the printing fluid and MgO as a binding agent (see below) has proved to be superior to MgSO₄ for the complete recovery of the materials.

Installation space: It is the geometric space in which the particulate material mixture is deposited during the construction process by repeated coating with particulate material and where the component is produced by selective binding. The installation space comprises a floor and 4 walls; it is open at the top.

Porosity: It describes the void volume in relation to the total volume of a substance or a mixture of substances. In mould making, excessive porosity is detrimental to strength and the coating, especially in no-fines structures.

Coating: A waterproof hydrophobic layer, which, for the purposes of the invention, is also resistant to hydraulic and non-hydraulic binding agents and resistant to UV radiation and mechanical influences. It forms the boundary between the additively manufactured mould and the material cast into the mould.

Cold casting processes are casting methods in which the temperature of the casting mould and the core, the decomposition or softening temperature of the mould material and the coating are not reached before, during and after casting, e.g., concrete casting.

Mould, formwork, casting mould: refers to the additively manufactured mould that is coated and into which the material is cast in the cold casting process.

It is preferably envisaged that, furthermore, an adjusting agent for adjusting the viscosity of the printing fluid is provided. For example, rice flour or a liquid adjusting agent is used as the adjusting agent for adjusting the viscosity. In addition, the solution can be kept at a constant temperature of 20 to 25° C., since salt can be precipitated as the temperatures drop. By means of adjusting agents and the temperature, the dynamic viscosity of the printing fluid can be adjusted in ranges of 1-1000 mPa s, depending on the nozzle diameter and the requirements.

In one embodiment variant, it is envisaged that the mixture additionally comprises a filler.

It is preferably envisaged that the mixture has
10 to 70% by weight of binding agent,
30 to 90% by weight of aggregate,
0.01 to 3% by weight of filler.

The binding agent can be selected, for example, from the group consisting of calcium oxide, cements, calcium sulfate, magnesium oxide, magnesium sulfate, loam-clay, trass, or mixtures thereof.

Particularly preferably, it is envisaged that the binding agent comprises magnesium oxide.

It has proved to be advantageous if the aggregate has a density of 50 kg/m³ to 1,600 kg/m³. Suitable aggregates which have such a density are selected, for example, from the group consisting of expanded clay, expanded perlite, expanded mica, expanded glass, expanded slate, pumice, wood chips, lava stone foam lava, boiler sand, sintered hard coal fly ash or recycled or waste building materials made of gas-aerated concrete, brick building materials or mixtures thereof.

The aggregate can have different grain sizes. Preferably, the grain size distribution of an ideal particle-size distribution curve has A(d)=(d/dmax)^{q} with a grain mixture of 0.2<q<0.7.

In the equation for the ideal particle-size distribution curve, A(d)=(d/dmax)^{q} means
A=through fraction in % by mass per grain size (value on the y-axis in the chart)
d=grain diameter between 0 and D for which the percentage in the grain mixture is to be calculated
D=diameter of the maximum grain size of the particle-size distribution curve to be calculated
q=exponent for taking the grain shape into account. For an ideal spherical shape: q=0.5; for gravel sand: q=0.4, for broken natural sand: q=0.25.

With this formula, the densest packing of the grains can be calculated, and the mass fractions per grain size that should be added to the dry mixture are obtained. The more the grain shape deviates from the spherical shape, the finer the aggregate must be and the larger the amount of MgO in the mixture, since non-spherical grains have a larger surface area that has to be bound.

In this way, black wash or, respectively, pore filling can be avoided, whereby one work step and one drying less are required so that time savings are possible.

The filler is preferably selected from the group consisting of fines, methyl cellulose, bentonite or combinations thereof. The task of the filler is to fix the printing fluid applied to the mixture in the particle bed.

Aggregates are powdery substances which influence the characteristic of the dry mixture. The following aggregates are preferably used:
(a) Methyl cellulose and/or bentonite: They improve the fluid retention capacity of the dry mixture. When printing fluid is sprayed onto the mixture, these additives fix the fluid locally in the powder bed at the point of fluid release. By adding methyl cellulose or bentonite, the fluid in the granular structure remains at the point where it was released and does not migrate through the powder layers due to gravity, which leads to so-called elephant feet in the components. It thus becomes possible to produce shape-retaining components with high precision. Added quantity: 0.01-3% by volume.
(b) Grain sizes of up to 0.125 mm are referred to as fines. Fines are beneficial for closing small cavities, thus increasing the strength of the casting mould. In addition, they promote the conveyance of the dry mortar through the pneumatic transport tubes and facilitate the trickling of the dry mortar. The finest aggregates can be used as fines. The fines close the pores and thus it is not necessary to use a black wash or filling like in the prior art. Added quantity: up to 3% by volume. In this case, quartz powder is preferably used, as it is very suitable as a filler and provides the 3D printed mould with a closed, hard surface that can still be processed due to the fineness of the quartz powder. The formwork skin adheres better to moulded components produced with a small addition of quartz powder and is more resistant due to the harder substrate.
(c) Reactive fillers, e.g., pozzolans. Pozzolans are substances containing silicic acid or alumina that can react in an alkaline manner, e.g., by adding water, magnesium chloride, lye, water glass, etc. Such reactive fillers or additives are:
(i) Fly ash: Fly ash is understood to be dust-like combustion residues of coal dust that are rich in silicic acid or lime and accumulate when the flue gases from steam generators in coal-fired power plants are cleaned. Fly ash consists of spherical particles with pozzolanic properties, which have several advantages. The advantages are an improved compaction ability of the particulate material during application and deep rolling. Better post-curing, higher final strength, denser structure and reduced tendency to crack. Fly ash improves the grain distribution of the particulate material mixture in the finest grain range and, in connection with the predominantly spherical grain shape (ball bearing effect), the processability and flowability of the particulate material. By means of the fly ash, tiniest pores in the particulate material mixture can thus be filled better, which leads to a denser structure of the final component and hence greater strength characteristics. Fly ash consists predominantly of reactive SiO₂ and aluminium oxide Al₂O₃ and small amounts of other oxides which can be stimulated in an alkaline manner. The silicic acid contained in fly ash is amorphous and similar to the glassy state. The individual SiO₂ molecules are therefore able to react with acids and bases. The magnesium hydroxide Mg(OH) 2 formed during the reaction prompts the fly ash to react, whereby a second geopolymeric structure is created. As a result, the high proportion of pores in the 3D printed structure can be further reduced.

As a by-product of energy production, fly ash has an excellent CO₂ balance and helps to conserve natural resources as more energy-intensive binding agents can be replaced. The recyclability and re-calculability of the MgO is thereby preserved. As a component in the particulate material mixture, fly ash can replace between 3 and 45% of the more expensive MgO and can render the particulate material mixture cheaper.
(ii) Microsilica, silica fume: It is an artificial pozzolan with a high proportion of silicic acid (silicon dioxide SiO₂). It is a glassy amorphous silicon dioxide. Silica fume accumulates as a by-product during the production of silicon and ferrosilicon alloys. The particles contained in silica fume are spherical, and, with their particle size of 0.1 to 0.2 μm, they are 50 to 100 times finer than cement particles. According to standard, their specific surface area should have a value of 15 to 35 m²/g. Microsilica is therefore an extremely fine-grained mineral substance. The chemical composition of silica fume can vary widely. In general, the silicon dioxide content is between 80% by weight and 98% by weight. The high degree of fineness causes the pronounced void-filling effect and the pozzolanic effect of silica fume. In addition, silica fume improves the bond in the contact zone between magnesium oxide and the aggregate or the fibres, respectively. Moreover, the packing density is increased. As a result, the strength properties can be improved by adding microsilica. In this case, the amount added to the mixture is between 1 and 20% of the MgO fraction. Because of the grinding fineness, the microsilica is highly reactive and reacts with the magnesium hydroxide Mg(OH) 2. The high specific surface area leads to a contact surface reaction, which results in a reduction of the capillary pores.
(iii) Other additives can be finely ground brick dust, metakaolin or calcined clay. A mixture of fly ash and microsilica is preferably used. The material properties of a 3D printed mould can thereby be improved. As a result, the mould becomes very durable and could be reused up to 40 times in experiments.

The printing fluid preferably has a magnesium chloride concentration of at least 30% by weight, preferably from 45 to 55% by weight.

The formwork skin can comprise, for example, thermosetting plastics, preferably polyurethane or epoxy resin, unsaturated polyester resin or phenoplasts.

It has been shown that a mixture of a binding agent and an aggregate can be obtained from a used casting mould, whereby complete recovery becomes possible. In particular, the casting mould can be produced beforehand using the method according to the invention. First, the formwork skin is removed from the used casting mould, and then the casting mould is crushed without the formwork skin, the particulate material is separated, and the binding agent is re-calcined.

The entire method is preferably performed in a 3D printer.

### DETAILED DESCRIPTION OF THE INVENTION

To enable an economical production of an additively manufactured casting mould, an inexpensive, reusable particulate material is required which can be conveyed easily and can be applied to the print bed in high-density layers without causing large pore spaces in the component. In addition, the particulate material should be a lightweight construction material so that the finished moulds can be lifted, set down and transported more easily. If the moulds are very heavy, this often causes problems when handling the moulds. Furthermore, the high dead weight of the moulds necessitates a higher strength of the material. It is advantageous for the further use of the casting mould and costs are reduced if the additively manufactured casting mould has a low dead weight.

Furthermore, a particulate material mixture which can be penetrated by the printing fluid of the print head when the layer thicknesses are greater is advantageous. This involves the advantage that the casting mould can be manufactured in layer thicknesses of between 0.5 mm and 5 mm, thus significantly reducing the production time. However, the fluid, which passes through the print head at those locations where the mixture is to be selectively bound, must penetrate through the entire layer thickness and combine with the layer bound in a previous process step. This can be easily accomplished by choosing a particulate material consisting of only one grain size, thus producing a no-fines structure.

However, these pores have a negative effect on the strength properties and on further processing in further process steps, since further process steps are necessary for closing the large pore spaces (black washes in the prior art). In addition, the surface of the mould and the mould itself should be easy to process, e.g., by grinding-cutting machines. Since the prior art discloses that the particulate material of such a mould consists of sand, generally quartz sand of a certain grain size, it would probably be difficult to rework such a mould made of sand due to the great hardness displayed by quartz sand. The prior art shows casting moulds for cold casting processes, which either themselves are made of plastic, or casting moulds in which the binding agent preferably consists of organic materials, such as, e.g., furan resin. The costs associated with using organic binding agents are considerably higher than when inorganic binding agents are used.

Finally, the most important property of the material mixture was identified to be its reusability and recyclability. The aim of the inventive process was to find a material mixture which is not very sensitive in its application and can be prepared by a simple, short process step. Upon processing, the entire material the additively manufactured mould is made of can be completely returned to the production process without residual masses being created that have to be disposed of at great expense, like in the prior art. This also reflects the zeitgeist of sustainability and CO₂ reduction. Magnesium oxide, which can be re-calcined, namely recovered, is preferably used as the inorganic binding agent, thus resulting in zero-waste production. The prior art in mould making for cold casting processes largely produces toxic waste.

According to the invention, the aim was therefore to find a material mixture that is lightweight and still achieves good strength values, and the components of which are very cheap for mass production and are completely recyclable and can be returned to the production process after use. Furthermore, the surface of the 3D printed mould should be easily processable. In order to meet those requirements, lightweight construction materials are advantageous in the construction industry, which are used as aggregates in the particulate material mixture. Such lightweight construction materials with a density of 50 kg/m³ to 1400 kg/m³ can be: expanded clay, expanded perlite, expanded mica, expanded glass, expanded slate, pumice, wood chips, lava stone foam lava, boiler sand, sintered hard coal fly ash or recycled or waste building materials made of gas-acrated concrete, brick building materials, preferably, however, expanded clay, expanded perlite or expanded glass. These aggregates have a natural origin or are man-made from natural raw materials such as clay by an expansion process. What these lightweight aggregates have in common is that they are available globally in large quantities and are significantly cheaper than organic plastic compounds.

In order to avoid no-fines structures, such aggregates are mixed in different grain sizes. In this case, the optimal grain size distribution corresponds to the ideal particle-size distribution curve A(d)=(d/dmax)^{q} with q=0.5, which is regarded to be a favourable grain size distribution according to Fuller and Thompson. With this grain size distribution, the void content is relatively low; grain mixtures with the fewest voids occur at q=0.4; grain mixtures with 0.2<q<0.7 are preferably used.

In comparison to sand made from a single grain size (like in the prior art), the grain size distribution of lightweight aggregates with the fewest voids has the advantage of having virtually no large open pores, which have to be closed subsequently in a further process step with a black wash, etc. In addition, the grain size distribution low in voids increases the strength of the casting mould compared to a no-fines casting mould made of sand of only one grain size. The proportion of aggregates in the total mixture can be 30-90% by weight. Conventional inorganic binding agents have proved their worth as binding agents for binding the aggregates. These binding agents can be calcium oxide, cements, calcium sulfate (anhydrite), calcium sulfate dihydrate (gypsum), magnesium oxide, magnesium sulfate, loam-clay, trass, but preferably cement, calcium sulfate dihydrate or preferably magnesium oxide. Such binding agents can occur individually or in combination within the mixture. Their proportion in the total mixture is 10-70% by weight. The aggregate and the binding agent are mixed prior to the application of the print bed. In order to have the lowest possible void content in the particulate material mixture, said mixture is conveyed into the feed trough by a pneumatic suction conveyor and is drawn onto the working plane-printing plane over the entire surface with the help of a squeegee and is then compacted with a trailing roller. In order to increase the water retention capacity of the particulate material and thus achieve greater shape accuracy of the 3D printed component, a filler such as methyl cellulose or bentonite can be added to the particulate material. In this case, the amount that is added is 0.01%-3% by weight of the total amount of the particulate material. The particulate material sets as a result of the fact that water with magnesium chloride is selectively applied from the print head in those places where the component is supposed to harden. The viscosity of the printing fluid can be adjusted with an adjusting agent (also a thickening agent). After a hardening time of a few hours, the hardened component can be freed from loose, non-set particulate material and can be cleaned. The component has a high early strength and can thus be supplied directly to the next step in the process chain, coating. During coating, the formwork skin is applied to the additively manufactured mould.

The mixture of binding agent and aggregate in conjunction with the printing fluid is based on Sorel cement, which is an acid-base cement. In this case, magnesium chloride is usually used as the acid, and magnesium oxide (MgO, caustically burnt magnesite) is normally used as the base, for which reason the presence of MgO in the binding agent is advantageous. A reaction takes place between magnesium chloride and magnesium oxide, which, depending on the grinding fineness and the burning time of the magnesium oxide, can cause the mixture to harden within a few minutes. For dimensional stability and in order to improve the water retention capacity, bentonite or methyl cellulose is added to the dry mixture. The resulting natural adhesive bonds very well to all materials such as all mineral construction materials and rock dust, and it also binds wood dust, wood chips, straw, etc. better than cement or gypsum. One advantage of magnesium oxide is that it can be re-calcined, i.e., burnt once more, and can be used for another production of 3D printed moulds.

In powder form, MgO hardens in the presence of a concentrated magnesium chloride solution (MgCl₂). A gel thereby forms in the MgO—MgCl₂—H₂O, which then hardens like a stone when exposed to air. In doing so, the following reactions take place at room temperature:
a) 5 MgO+MgCl₂+13 H₂O→5 Mg(OH)₂·MgCl₂·8H₂O (5-1-8 phase)
b) 3 MgO+MgCl₂+11 H₂O→3 Mg(OH)₂·MgCl₂·8H₂O (3-1-8 phase)
c) MgO+H₂O→Mg(OH)₂

Hardening occurs through the mutually penetrating and matting fine crystal needles of the emerging magnesium hydroxide. Hardening is completed within a few hours, which is a significant benefit for powder 3D printing. The 5-1-8 phase and the 3-1-8 phase are relevant. There are other phases, but they are irrelevant for practicing at room temperature. During hardening for setting, needle-shaped crystals separate from the initially emerging gelatinous mass. The structure of the stable hydrate phase is derived from that of magnesium hydroxide, which consists of double chains. The chain link is the reason for the high strength of the hydrate phase. The magnesium carbonate is generated by the reaction of the magnesium hydroxide formed with the CO₂ in the air.

Example recipes for the particulate material (the ratio of MgO and MgCl remains constant): Expanded glass as an aggregate: (expanded glass is waste glass that has been inflated)

| Substance | Parts by weight |
|---|---|
| Expanded glass 0.25-0.5 mm | 9 |
| Expanded glass 0.1-0.3 mm | 2 |
| Fine sand 0-0.125 mm | 1 |
| MgO | 6 |
| Methyl cellulose | 0.25 |
| Fly ash and microsilica | 1 |

Expanded clay as an aggregate: (expanded clay is clay that has been expanded)

| Substance | Parts by weight |
|---|---|
| Expanded clay 0.2-0.4 mm | 8 |
| Expanded clay 0.1-0.2 mm | 3 |
| Fine sand 0-0.125 mm | 1 |
| MgO | 6 |
| Methyl cellulose | 0.25 |
| Fly ash and microsilica | 1.25 |

In test series, advantages of magnesia binder-Sorel cement over Portland cement and other mineral binding agents in 3D printing were identified:

Considerable strengths can be achieved with lightweight construction aggregates that cannot be achieved with Portland cement in this way.

Fire resistance.

Magnesia cements do not conduct heat, cold or electricity.

With the binding agent MgO, all organic and inorganic aggregates as well as the finest dusts can be bound to form end products with suitable strengths. This is not possible with Portland cement.

Rapid hardening, which allows faster processing times.

Shape accuracy and no development of cracks.

Minor adhesions of the dry mortar to the component when unpacking, which significantly reduces the post-processing of the component compared with cement or gypsum.

The high temperatures that arise in the setting reaction due to the large mass of a casting mould of 10 m³ bother the magnesia binder less than the Portland cement.

The lower burning temperature of magnesia binder, which contributes to energy savings and CO2 reduction. An MgO burning temperature of approx. 800° C. and that of Portland cement of 1300° C.

Re-calcinability of the MgO, which thus renders the binding agent reusable, currently as the only known binding agent, and thus makes components-casting moulds made of the above-mentioned dry mortar mixture-recyclable by 100%.

The material that is not hardened by selective binding in the 3D printing process can be reused more often. Tests yielded only minor losses in strength, even after 7 times of reuse. In order to be able to reuse the material in the 3D printing process, it only needs to be sieved and mixed again, adding a small amount of unused MgO (10%). In doing so, small ejection amounts are generated by sieving. This is possible in this form only with MgO. Portland cements and CSA cements cause significantly higher ejection amounts due to larger adhesions and lose strength significantly when reused. This is probably due to the fact that Portland cements are highly hygroscopic and, in the 3D printing process, the fluid resulting from printing and the water vapour resulting from curing are attracted.

Since the content of binding agent in the powder mixture is very high, this implies a significant cost advantage over a printer with a print volume of 10 m³ per print. Hence, this makes the method sustainable and economical for the construction industry. Moreover, the entire material can be kept in circulation while being reused.

The recycling of the material was accomplished without any deterioration in the quality of the casting moulds. Because of the use of lightweight aggregates, the mould has a significantly lighter weight than moulds made of sand and is also at least as strong, if not stronger. Since lightweight aggregates have a softer inherent grain strength, the mould can be reworked easily, similarly to wood.

In the following, it is described according to the invention how such a mould can be produced economically, is recycled and the starting material of the mould can be reused for the production of new moulds.

The surface of a mould formwork that comes into contact with the component, for example for concrete components, is referred to as a coating formwork skin. The requirements for the coating or, respectively, formwork skin in the cold casting process are explained below using the material concrete as an example. Since the

In order to meet the requirements for the formwork concrete surfaces, various elements of the formwork, in this case of the additively manufactured casting mould with a formwork skin, are classified in the so-called formwork skin classes SHK 01 to SHK 03. The formwork classes thus describe the formwork skin, the use condition, the texture, the surface structure, the formation of edges, etc.

In this case, the absorbency of the formwork skin has a significant influence on the desired exposed concrete result of the visible surface. Depending on whether the formwork skin is absorbent or non-absorbent, the desired result can be different. An absorbent formwork skin removes air and excess water from the concrete edge zones, whereby surfaces with few pores and a relatively uniform colour are formed.

In contrast, a non-absorbent formwork skin enables the production of almost smooth surfaces. However, it promotes the formation of pores, marbling, cloudiness and colour differences. Such areas tend to appear rather bright.

It is thus possible to design a variety of exposed concrete surfaces according to customer requirements, depending on the type of formwork skin and the texture applied to the surface of the casting mould by the 3D printer. A printed texture of the casting mould surface combined with the specific properties of the formwork skin significantly increases the design options for the exposed concrete surface.

Because of the special requirements, a coating made of thermosetting plastics such as polyurethane or epoxy resin, unsaturated polyester resin or phenoplasts has proved its worth as a formwork skin. In this case, polyurethanes that are highly elastic, have good mechanical properties such as abrasion resistance, thermal resistance, monolithic design, full-surface adhesion and good water vapour diffusion, preventing the formation of bubbles, are preferably chosen. The coating is applied in the liquid state with a roller or brush or is sprayed on using a spraying system. Spraying/jetting is suitable especially for complicated surfaces and is very economical. The coating has a thickness of 0.1 mm-1.5 mm and can easily transfer the textures printed on the mould to the concrete. If no textures are desired, an absolutely smooth coated surface can be produced by smoothening the surface of the casting mould.

It is therefore important that the 3D printed moulded body can be easily processed by grinding and polishing machines, as it is the case with lightweight construction materials. After the coating has dried, the formwork can be provided with a customized release agent and is immediately ready for use and can be reused very often if used carefully. If the formwork skin is worn out, it can be cleaned and coated again with PU and repaired. Irregularities, scratches or damage can be filled with gypsum, for example, and can be ground off. The system is thus also easy to repair in case of damage to the mould and the coating. If special exposed concrete surfaces with deep structures or very delicate structures are desired, prefabricated formwork matrices made of PU or silicone, for example, can be glued onto the coating. Furthermore, it is possible to glue textile formwork sheets, tiles or films, which are coated with setting retarders using screen printing processes, onto the coating, which opens up further possibilities for architectural surface design.

The coated mould itself can also serve as a basic mould for moulding with moulding compounds such as soft PU or silicones in order to produce components with particularly delicate specifications. The soft moulding compounds have the advantage that they can be removed from the mould more easily.

Due to its robustness and simple repair options, the formwork is usable across many cold casting operations. Should its life cycle come to an end, the aim is to recycle the entire casting mould and to reuse the base material of the moulded body ideally for the production of new formworks. The recycling process starts with the removal of the formwork skin. This can be done mechanically by milling off, scraping off, scratching off, chemically by spraying a solvent or thermally by heating and scraping off. Since the formwork skin is very thin (0.1-1.5 mm), only small amounts of plastic waste are generated.

The additively manufactured casting mould is produced in a 3D printer according to the binder jetting process known in professional circles. After the casting mould has been manufactured in the 3D printer, the casting mould must be freed from unbound particulate material and cleaned during binder jetting. After cleaning, the casting mould is prepared for coating. In doing so, formwork aids are optionally installed and the mould is reworked if necessary. After cleaning off the loose particulate material, the mould can be taken for coating after a drying time of a few hours. After the coating has dried and hardened, it can be supplied directly to the production of the component in the cold casting process. The release agent is sprayed onto the casting mould. If necessary due to static requirements, the reinforcement made of iron or textiles can be installed. Finally, the component can be produced in the cold casting process. For this purpose, for example, a mixture of concrete can be used, or other materials suitable for construction are used, such as, e.g., gypsum, lime or clay-loam together with an aggregate. After the components have hardened, they can be dismantled from the formwork.

The formwork aids which carefully detach the component from the formwork of the mould are used for this. By means of a lifting equipment such as a crane, the components can be lifted out of the mould and taken for further processing. The mould is cleaned and again provided with a release agent and prepared for the next casting operation. It can also be used merely as a so-called one-off mould with batch size 1. If used once, the mould will be recycled after use. In doing so, the formwork skin is removed by a mechanical, thermal or chemical method. Preferably mechanically and/or chemically. After the formwork skin has been removed, the mould is broken down into pieces suitable for the crusher and is broken in a crusher suited for this purpose. The crusher can be a jaw crusher, cone crusher or impact crusher. An impact crusher is preferably used. Dry processing methods or wet processing methods can be employed as processing methods, dry processing is used preferably. After shredding the material with a crusher, there are two options for recycling the broken particulate material, depending on the size of the accumulated material:
a) Recycling and returning the material to the material cycle without re-calcination (without again burning MgO): This processing method is preferably employed for smaller material quantities and throughputs and constitutes an inexpensive way of recycling a particulate material, since the burn process including the devices necessary therefor can be omitted. After crushing, the shredded particulate material can be further shredded to the desired grain sizes in an attrition drum or by a high-voltage digestion method, or it is immediately sent for screening by air separation or sieving. After screening, preferably by sieving, the different grain sizes of the particulate material are collected in storage containers. When producing a new particulate material mixture for the 3D printing process, the recycled particulate material is added to it as an aggregate. The new particulate material mixture can consist of up to 5-70% recycled particulate material mixture, preferably 40% recycled particulate material mixture is added as an aggregate.
b) Recycling and returning the material to the material cycle without re-calcination (with burning the MgO again): This processing method is preferably employed for large material quantities and high throughputs. Through re-calcination, the costs for the binding agent MgO can be reduced additionally, as neither dismantling costs nor transport costs will accrue. The material shredded by the crusher, preferably an impact crusher, can be further processed by the attrition method in the attrition drum or by high-voltage digestion methods and can be separated into its basic components aggregate and binding agent. The attrition drum circulates the material at low speed, subjecting the surface of the particles to a frictional force between the particles and the drum wall and the particles. Because of this friction, the aggregates and the particles of the binding agent can separate further due to their different degrees of hardness. By screening with the aid of air separation or sieving, the components are graded according to particle size or particle density. The aggregate obtained in this way (e.g., expanded clay, expanded glass) can be used directly for a new particulate material mixture for the production of a new mould. The binding agent is calcined again in an oven, preferably a rotary tubular kiln or a fluidized bed furnace. This process of another burning is referred to as re-calcination. During re-calcination, the magnesium oxide, which already has solidified once, regains reactivity. In doing so, the following processes take place:
a) Mg(OH)₂+heat→MgO+H₂O
b) MgCO₃+heat→MgO+CO₂·

The magnesium chloride or magnesium sulfate present in the particulate material also breaks down when heated. During thermal treatment, the magnesium chloride splits into magnesium oxide and magnesium oxychloride and hydrogen chloride. The magnesium sulfate splits into magnesium oxide and sulfur dioxide. Since the waste gases contain magnesium oxide, the sulfur dioxide can be converted back into magnesium sulfate or, respectively, the hydrogen chloride can be converted into magnesium chloride, through the introduction of water fog by means of a quench. These can each be filtered then and returned to production.

Hence, all substances can again be used for the production of a new particulate material mixture and for the production of a new mould in a 3D printer. In this case, the amount of binding agent can consist of a mixture of recycled and unused binding agents. The ratio is thus preferably between 40% recycled and 60% new binding agents or between 50% and 50%.

The material MgO and the method according to the invention of producing casting moulds and components enable virtually 100% recycling and are sustainable. This is in contrast to moulds which currently have to be produced from wood, styrofoam, gypsum, etc. conventionally by hand or with the help of milling machines and have to be disposed of afterwards.

1. A method of producing an additively manufactured casting mould for the production of components using the cold casting process or lamination process, comprising the steps of
a) determining a three-dimensional structure of the casting mould,
b) providing a mixture, the mixture comprising a binding agent and an aggregate,
c) providing a printing fluid comprising an aqueous solution of magnesium chloride or magnesium sulfate,
d) applying a layer of the mixture to a support,
e) applying the printing fluid only to those parts of the mixture which are supposed to constitute a part of the casting mould,
f) applying a further layer of the mixture to the previous layer of the mixture,
g) applying the printing fluid only to those parts of the mixture which are supposed to constitute a part of the casting mould,
h) repeating steps f) and g) until the desired shape of the casting mould is achieved,
i) allowing those parts of the mixture to set which have been mixed with the aqueous solution of magnesium chloride or magnesium sulfate,
j) removing the mixture which has not been mixed with an aqueous solution, and
k) coating with a formwork skin at least those parts of the casting mould which come into contact with the material of the cold-casting lamination process.

2. A method according to claim 1, wherein the mixture additionally comprises a filler.

3. A method according to claim 2, wherein the mixture has
10 to 70% by weight of binding agent,
30 to 90% by weight of aggregate,
0.01 to 3% by weight of filler.

4. A method according to claim 1, wherein the binding agent comprises calcium oxide, cements, calcium sulfate, magnesium oxide, loam-clay, trass, or mixtures thereof.

5. A method according to claim 1, wherein the binding agent comprises magnesium oxide.

6. A method according to claim 1, wherein the aggregate has a density of 50 kg/m³ to 1,400 kg/m³.

7. A method according to claim 1, wherein the aggregate comprises expanded clay, expanded perlite, expanded mica, expanded glass, expanded slate, pumice, wood chips, lava stone foam lava, boiler sand, sintered hard coal fly ash or recycled or waste building materials made of gas-aerated concrete, aerogels, brick building materials or mixtures thereof.

8. A method according to claim 1, wherein the aggregate has different grain sizes, wherein the grain size distribution of an ideal particle-size distribution curve preferably is A(d)=(d/dmax)^{q} with a grain mixture of 0.2<q<0.7.

9. A method according to claim 1, wherein the filler comprises fines, methyl cellulose, bentonite, or combination thereof.

10. A method according to claim 1, wherein the printing fluid has a magnesium chloride concentration or magnesium sulfate concentration of at least 30% by weight, preferably from 45 to 55% by weight.

11. A method according to claim 1, wherein the formwork skin comprises thermosetting plastics, preferably polyurethane or epoxy resin, unsaturated polyester resin, or phenoplasts.

12. A method according to claim 1, wherein the mixture of a binding agent and an aggregate is obtained from a used casting mould, which, in particular, was produced beforehand according to claim 1, wherein, first, the formwork skin is removed from the used casting mould, and then the casting mould is re-calcined and crushed without the formwork skin.

13. A method according to claim 1, wherein it the method is performed with a 3D printer.

14. A method according to claim 13, wherein the 3D printer has a control, the three-dimensional structure of the casting mould being entered into the control, the 3D printer having
(i) a receiving and metering unit for the mixture,
(ii) a receiving and metering unit for the printing fluid;
(iii) optionally a receiving and metering unit for an adjusting agent for adjusting the viscosity of the printing fluid, and
(iv) a support,
wherein the control performs the steps (a) to (k) by controlling the one receiving and metering unit for the mixture, the receiving and metering unit for the printing fluid and optionally a receiving and metering unit for an adjusting agent for adjusting the viscosity of the printing fluid.

15. A method of producing a component, wherein, first, a casting mould is provided in a method according to claim 1, and then a material is cast or laminated into the provided casting mould and is cured.

16. A method according to claim 15, wherein the material is concrete.

17. A method according to claim 15, wherein the material is selected from the group consisting of inorganic castable and laminable materials such as, e.g., gypsum, ceramic materials, loam, clay, fibre cement, and organic castable and laminable materials such as, e.g., casting resins made of polyurethane and epoxy, silicones, glass fibre reinforced plastics and carbon fibre reinforced plastic.

18. A method according to claim 1, wherein the printing fluid comprises an aqueous solution of magnesium chloride, and preferably is an aqueous solution of magnesium chloride.

19. (canceled)
